(19) United States
(12) Patent Application Publication
(10) Pub. No.: US 2010/0007157 A1
(43) Pub. Date: Jan. 14, 2010

(54) LATCH ASSEMBLY FOR BI-FOLD DOORS

(76) Inventors: JOHN R. TEUTHORN, Glendale Heights, IL (US); James M. Teuthorn, Lindenhurst, IL (US)

Correspondence Address: Martin Faier, Faier & Faier, P.C.;#600, 566 W. Adams St., Chicago, IL, 60661, US

(21) Appl. No.: 12/494,167

(22) Filed: Jun. 29, 2009

Related U.S. Application Data
(60) Provisional application No. 61/079,702, filed on Jul. 10, 2008.

(51) Int. Cl. E05B 15/02

(52) U.S. Cl. 292/340

(57) ABSTRACT

A latch assembly for locking one or more bi-fold doors in a frame which has a bracket for pivotably securing the latch assembly in a selected position relative to the doors and frame; and the latch assembly has a stepped bar having an intermediate section pivotally arranged in the bracket, a latching leg extending outwardly from the bracket perpendicular to the intermediate section and a handle leg extending outwardly from said bracket perpendicular to the intermediate section remote from the latching leg, whereby pivotal manipulation of the handle leg causes the latching leg to latch or unlatch the door in the frame.

### PRIORITY CLAIM

Priority is claimed from U.S. Provisional Patent Application Ser. No. 61/079,702, filed Jul. 10, 2008 for a LATCH ASSEMBLY FOR BI-FOLD DOORS.

### BACKGROUND AND SUMMARY OF THE INVENTION

This invention relates to a latch assembly for bi-fold door assemblies and is more particularly concerned with such assemblies which are arranged in a frame and may be used to retain closed a series of two or more door panels which are hinged together on their side edges.

Such bi-fold door assemblies have come into common usage where an opening in a frame may be closed without the necessity of having a door swing the full width of the closure to open and close the door. Such bi-fold door assemblies are frequently used for closures of closets, windows, shutters, cupboards and other closures where opening and closing space is at a premium or not available. The problem with such door arrangements is that the panels often remain open or are easily opened by pressing against the hinged side of the doors to move them into folding arrangement. Small children, particularly, are drawn to such door arrangements often resulting in unintended access to the closed closet or other contained area intended to be closed by the doors, and frequently, a person, particularly a child, may have a pinched finger or be otherwise injured when such doors are closed or opened.

Some systems have been created to latch or lock the doors together or in the frame. For example, some devices have been installed between the doors remote from the hinged panels, such as the locking device disclosed in Robert U. Johnson, LOCK FOR BI-FOLD DOORS AND THE LIKE, U.S. Pat. No. 4,903,747. However, such devices are usually installed at a height where they can be reached by children, who can open or close the doors, intentionally or unintentionally. Such devices usually require drilling or cutting out material from the doors, thus weakening the closures.

Another latching device, such as Richard J. Clark LATCH FOR FOLDING AND SWINGING DOORS, U.S. Pat. No. 4,228,842, comprises a movable channel which can be slid along the top edge of the doors to bridge adjacent bi-fold doors, but such devices are not adequately versatile to accommodate doors of varying thickness. Such devices also require the person using them to reach to the top of the doors to slide them into or out of position, and the doors must be suitably aligned to permit movement of the bridging member across both doors. These arrangements are particularly inconvenient for persons of inadequate height to reach to top edge of the doors.

Another device similar to Clark is disclosed in Miki E. Beese LOCKING DEVICE, U.S. Pat. No. 4,372,592, which includes a locking bolt selectively insertable between the hinged together doors. This device requires suitable space between the doors for the insertion of the bolt, and, in addition, has the problems discussed above in Clark.

Richard J. Haines U.S. Pat. No. 4,082,329 for a PRIVACY LOCK FOR FOLDING AND SLIDING DOORS is somewhat like Johnson and only latches the remote door to the frame. Such a device requires exact alignment with the frame or the actuator will not latch.

In applicant's device, a tubular member is attached to and across the top edge of one of the doors in the vicinity of the joined hinged door. A stepped rod having a handle end and a latching end, joined together by an intermediate member is inserted into and slidably engaged in a tubular member, which may be connected to a door or its frame. Movement of the handle to a point where the handle end is substantially parallel to the top edge of the door will cause the latching end to be arranged parallel to that door top edge to permit folding of the doors as desired. Movement of the handle to a point where the handle end is substantially perpendicular to the top edge of the door will cause the latching end to be moved upwardly behind the frame or a top rail to positively latch the doors closed to the frame.

Preferably a vinyl tube or a similar slidable surface is inserted into the tubular member to ease movement of the intermediate member of the rod during latching and unlatching of the device into the frame. This vinyl tube frictionally engages the rod so that it remains in the set position, but can be manually moved to another position to latch or unlatch the door.

### OBJECTS AND ADVANTAGES OF THE INVENTION

It is the object of the invention to provide a latching device for folding doors of the character recited.

Another object is to provide a latching device for folding doors arranged in a frame which has a stepped bar having an intermediate section pivotally secured to the top edge of a bi-fold door or its frame, and having a first leg arranged extending perpendicularly from the intermediate section downwardly along a face of the door, and a second leg extending perpendicularly from the intermediate section opposed to said first leg, so that movement of first leg will cause the second leg to be moved behind a door frame or header to latch the door into a close position in the frame.

Another object is to provide such a latching arrangement which permits the intermediate member to be easily moveable in a tubular support secured to the top edge of a bi-fold door or its frame.

Another object is to provide a handle for the first leg of the stepped bar to permit the intermediate section to easily pivot in a part securing it to the top edge of the door.

Another object is to provide a latch for bi-fold doors which is easily and efficiently manufactured from available materials, and which is simple to install and use.

These and other objects and advantages will become apparent as this description proceeds, taken in conjunction with the accompanying drawings.

### BRIEF DESCRIPTION OF THE DRAWINGS

FIG. 1 is an elevational of two sets of bi-fold doors comprised of four door panels latched together with devices embodying the present invention.

FIG. 2 is an enlarged perspective view part of a pair of bi-fold doors panels having a latch device on the top edge of a door.

FIG. 3 is a perspective view of part of a set of bi-fold door panels showing the latch in latched condition and in phantom illustrating a door frame, track or heater with the latch leg secured behind a door track or header or frame in latched condition.

FIG. 4 is an enlarged sectional view of the latch assembly on a door, taken on line 4-4 of FIG. 3.

FIG. 5 is an enlarged perspective view of the intermediate portion of the latch bar arranged in a bracket which may be secured to the top edge of a door, as shown in FIG. 3, or to its frame.

FIG. 6 is a side elevational view of the intermediate portion of the latch bar arranged in the vinyl sleeve and its bracket, taken on line 6-6 of FIG. 3.

### DESCRIPTION OF THE PREFERRED EMBODIMENT

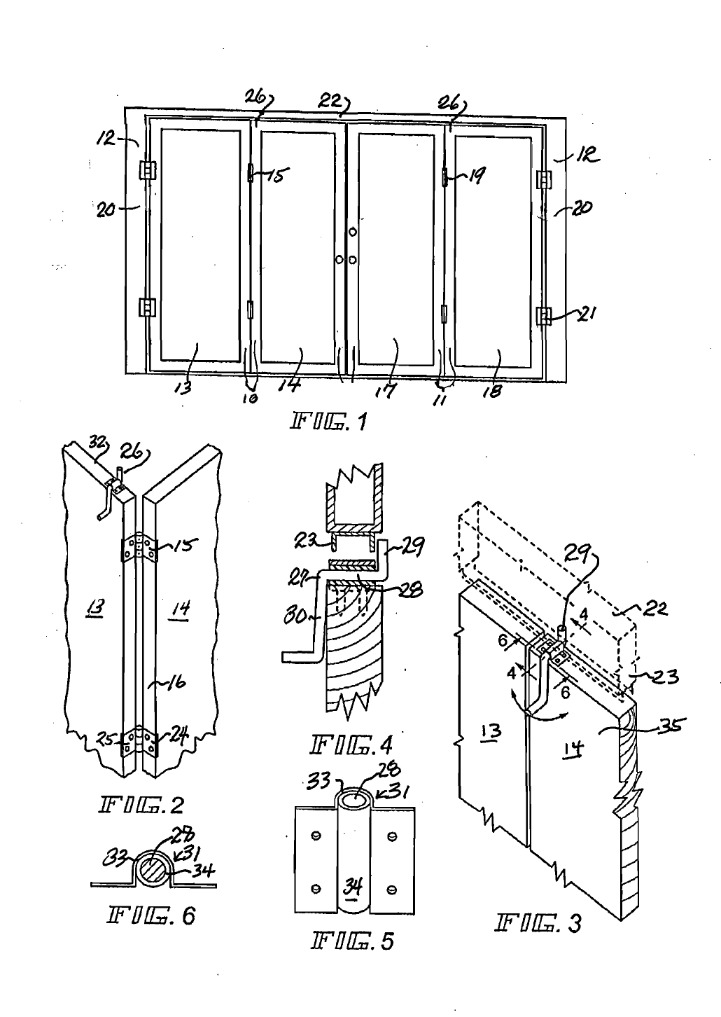

With reference to the accompanying drawings and particularly to FIG. 1, two sets of bi-fold doors 10 and 11 are mounted in a frame 12. One set of doors 10 has two panels 13 and 14, which are joined to one another by panel hinges 15 along facing edges 16 of each panel. The other set of doors 11 also has two panels 17 and 18 joined to one another by like hinges 19 along their facing edges.

The frame 12 may have a side jamb 20 which also carries side hinges 21 for mounting a panel 13 or 18 to the frame 12. The frame 12 also has a header 22, to which may be secured a door track 23. When the doors are open, as shown in FIG. 2, its panels 13 and 14 are folded along the panel hinges 15. When the doors are closed, the panels 13 and 14 are extended and the plates 24 and 25 of their panel hinges 15 are folded face to face. Each set of doors 10 or 11 have a novel latch assembly 26 embodying the present invention.

The latch assembly 26 comprises a stepped bar 27, which consists of an intermediate section 28 having at its one end a latching leg 29 arranged perpendicularly to the intermediate section and at its other end another leg perpendicular to the bar which comprises a handle leg 30. A bracket 31 is secured to the top edge 32 of the panel 13 or 14 on door set 10 and this bracket pivotally secures the intermediate section 28 of the bar to the door panel. The bracket 31 may be secured to the door panel top edge 32 by means of screws or like mounting means through holes in the bracket. This bracket 31 preferably has a tubular portion 33 enclosing the intermediate section of the bar 27 and may also have a vinyl or like tube 34 adjacent the intermediate section 28, so that the bar may be easily axially pivoted but remain in a selected position to latch or unlatch the leg 29 against the header 22 or track 23.

The latching assembly 26 may also be secured to the header 23 or the like in a position corresponding to the latch assembly mounted on the door as shown. The bracket 31 may be secured in the designated desired position by means of two or up to four screws in the unit with one or two screws on each leg, or other means on each of its legs to retain the stepped bar 27 in pivotable latching or unlatching position.

The latching leg 29 is sized to bear against the header 22 or track 23, but not to affect the folding opening or closing movement of the panels in the set on which it is mounted. The other perpendicular leg or handle 30 is sized to be aligned against the face 35 of the panel on which it is mounted. As the stepped bar 27 is pivoted in the bracket 31, the handle leg 30 is moved in an arc (as shown by arrows in FIG. 3). At the apogee of the arc, the latching leg 29 locks the doors closed against the header 22 or track 23, and at the perigee of the arc, the latching leg 29 unlocks the doors so they can be opened. The vinyl or like tube 34 frictionally holds the intermediate section 28 of the bar 27 in a selected open or closed position, but permits movement of the bar into a selected position as described.

While a preferred embodiment of the invention has been shown and described in considerable detail, it should be noted that changes in the structure may be made without departing from the spirit or scope of the invention, and it is not desired that the invention should be limited to the exact construction disclosed.

1. A latch assembly for locking one or more bi-fold doors in a frame, said latching assembly comprising:
a bracket for securing said latch assembly in a selected position relative to said doors and said frame;
said latch assembly being pivotably secured in said bracket and consisting of a stepped bar comprising:
an intermediate section pivotally arranged in said bracket;
a latching leg extending outwardly from said bracket substantially perpendicular to said intermediate section; and
a handle leg extending outwardly from said bracket substantially perpendicular to said intermediate section remote from said latching leg;
whereby manipulation of said handle leg causes said latching leg to latch or unlatch said door in said frame.

2. In the latch assembly recited in claim 1, wherein said latching leg and said handle leg are substantially parallel to one another.

3. In the latch assembly recited in claim 1, wherein said handle leg has a grasping member extending outwardly from said handle leg.

4. In the latch assembly recited in claim 1, wherein a tube is arranged around said intermediate section in said bracket.

5. In the latch assembly recited in claim 4, wherein said tube frictionally engages said intermediate section to hold said latch assembly in selected latched or unlatched position.

6. In the latch assembly recited in claim 5, wherein said tube is fabricated from vinyl or other flexible frictionally engageable material.

7. In the latch assembly recited in claim 1, wherein said legs are moved in an arc against one of said doors when manipulated into latched or unlatched position.

8. In the latch assembly recited in claim 7, wherein said doors are unlatched when said legs are in the perigee of said arc and latched when said legs are in the apogee of said arc.

9. In the latch assembly recited in claim 1, where said door has an inner face and an outer face, and said latch leg is arranged in alignment with the inner face of one of said doors and said handle leg is aligned with said outer face of said door.

10. In the latch assembly recited in claim 9, wherein the thickness of said doors is defined by the space between said faces, and said bracket and said intermediate section are of a size substantially the thickness of said doors.

11. In the latch assembly recited in claim 1, wherein said latch assembly is secured to one of said doors.

12. In the latch assembly recited in claim 11, wherein said latch leg is arranged against said frame when latched.

13. In the latch assembly recited in claim 1, wherein said latch assembly is secured to said frame.

14. In the latch assembly recited in claim 13, wherein said latch leg is arranged against one of said doors when latched.

15. In the latch assembly recited in claim 1, wherein said bracket has securing means for selectively mounting it to one of said doors or to said frame.

16. In the latch assembly recited in claim 1, wherein said doors have a top edge aligned in said frame and said latch assembly is arranged at said top edge.

17. In the latch assembly recited in claim 1, wherein said frame carries a header on an edge of said frame and said latch assembly latches against said header.
